(19) United States
(12) Patent Application Publication
(10) Pub. No.: US 2015/0220978 A1
(43) Pub. Date: Aug. 6, 2015

(54) INTELLIGENT MULTICHANNEL ADVERTISEMENT SERVER

(71) Applicant: International Business Machines Corporation, Armonk, NY (US)

(72) Inventors: Subil M. Abraham, Plano, TX (US); Praveen B. Dharmavaram, Chantilly, VA (US); Kirtana Raja, Bellaire, TX (US); Mathews Thomas, Flower Mound, TX (US)

(73) Assignee: International Business Machines Corporation, Armonk, NY (US)

(21) Appl. No.: 14/169,614

(22) Filed: Jan. 31, 2014

(51) Int. Cl. G06Q 30/02

(52) U.S. Cl. CPC G06Q 30/0251

(57) ABSTRACT

In accordance with the arrangements described herein, presentation of a first advertisement to a user in a first communication format via a first communication medium can be detected. A second communication medium being accessed by the user also can be detected. Responsive to detecting the second communication medium being accessed by the user, at least a second advertisement corresponding to the first advertisement can be presented to the user in a second communication format via the second communication medium, the second communication format being different than the first communication format.

### BACKGROUND

Arrangements described herein relate to presentation of advertisements.

Users view advertisements through various communication mediums such as radio, television, Internet, print and digital billboards. Most users would prefer very limited exposure to advertisements because advertisements presented often are irrelevant to the users. This is not always the case, however. Indeed, if an advertisement pertains to a particular product, service or event in which the user is interested, the user may desire to listen to and/or view the advertisement.

### SUMMARY

A method includes detecting presentation of a first advertisement to a user in a first communication format via a first communication medium. The method also includes detecting, by at least one processor, a second communication medium being accessed by the user. The method further includes, responsive to detecting the second communication medium being accessed by the user, presenting to the user at least a second advertisement corresponding to the first advertisement in a second communication format via the second communication medium, the second communication format being different than the first communication format.

A system includes a processor programmed to initiate executable operations. The executable operations include detecting presentation of a first advertisement to a user in a first communication format via a first communication medium. The executable operations also include detecting a second communication medium being accessed by the user. The executable operations further include, responsive to detecting the second communication medium being accessed by the user, presenting to the user at least a second advertisement corresponding to the first advertisement in a second communication format via the second communication medium, the second communication format being different than the first communication format.

A computer program product includes a computer readable storage medium having program code stored thereon. The program code is executable by at least one processor to perform a method. The method includes detecting, by the at least one processor, presentation of a first advertisement to a user in a first communication format via a first communication medium. The method also includes detecting, by the at least one processor, a second communication medium being accessed by the user. The method further includes, responsive to detecting the second communication medium being accessed by the user, presenting, by the at least one processor, to the user at least a second advertisement corresponding to the first advertisement in a second communication format via the second communication medium, the second communication format being different than the first communication format.

### BRIEF DESCRIPTION OF THE SEVERAL VIEWS OF THE DRAWINGS

FIG. 1 is a block diagram illustrating an example of a communication system.

FIG. 2 is a block diagram illustrating example architecture for a data processing system.

FIG. 3 is a flow chart illustrating an example of a method of presenting advertisements to a user.

FIG. 4 is a flow chart illustrating an example of a method of presenting advertisements to a user.

### DETAILED DESCRIPTION

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to presentation of advertisements and, more particularly, to presentation of advertisements across multiple communication mediums. In accordance with the inventive arrangements disclosed herein, presentation of a first advertisement to a user can be detected by at least one data processing system, such as one or more servers. The first advertisement can be presented to the user in a first communication format via a first communication medium. A second communication medium accessed by the user also can be detected by the data processing system(s). Responsive to detecting the second communication medium accessed by the user, the data processing system(s) can present to the user at least a second advertisement corresponding to the first advertisement. The second advertisement can be presented in a second communication format, which is different than the first communication format, via the second communication medium. In one arrangement, the first advertisement can be a first portion of an advertisement presentation and the second advertisement can be second portion of the advertisement presentation. In another arrangement, the second advertisement can be otherwise related to the first advertisement. For example, the first and second advertisements both can be directed to the same product, service or event. Accordingly, the presentation of the second advertisement can continue and/or reinforce a message being communicated to the user via the first advertisement. Moreover, the user is presented a unified advertisement experience across multiple communication mediums.

It should be noted that the first and second communication mediums can be any communication mediums suitable for presenting content and/or advertisements. For example, the first communication medium can be an audio channel, a television channel, an Internet Protocol (IP) based communication medium, a communication medium used to present information on digital billboards, and the like. Similarly, the second communication medium can be an audio channel, a television channel, an IP based communication medium, a communication medium used to present information on digital billboards, and the like. The first and second communication formats can be any formats used to encode content and/or advertisements over a communication medium. For example, the first communication format can be a communication format used to encode audio, video, audio/video, multimedia, still image and/or web page content. Similarly, the second communication format can be a communication format used to encode audio, video, audio/video, multimedia, still image and/or web page content. The first and/or second communication format also can be a communication format used to encode text configured to be placed into, overlaid onto, or otherwise streamed with video content. In another arrangement, the first and/or second communication format can be a communication format used to encode one or images for presentation on one or more displays.

Several definitions that apply throughout this document now will be presented.

As defined herein, the term “computer readable storage medium” means a storage medium that contains or stores program code for use by or in connection with an instruction execution system, apparatus, or device. As defined herein, a “computer readable storage medium” is not a transitory propagating signal per se.

As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), an application specific integrated circuit (ASIC) and a controller.

As defined herein, the term “server” means a data processing system comprising at least one processor.

As used herein, the term “display” means an output device that presents visual information. Televisions, tablet computers, laptop computers and smart phones, for example, include displays. A display also can be a discrete device connected to another device or system, for example a computer display (or monitor) or a digital billboard.

As defined herein, the term “user” means a person (i.e., a human being).

As defined herein, the term “content” means audio, video, audio/video, multimedia, one or more still images and/or one or more web pages communicated to at least one user via at least one communication medium.

As defined herein, the term “advertisement” means a public notice or announcement presented as content via at least one communication medium to promote a product, service, or event.

As defined herein, the term “communication medium” means a type of transmission channel over which audio, video, audio/video, multimedia, still image and/or web page content is communicated. Examples of a communication medium include, but are not limited to, a television transmission (e.g., via a transmission tower, satellite, cable television system, etc.), a radio transmission (e.g., via a transmission tower, satellite, cable television system, etc.), Internet communication, communication to a digital billboard, and the like.

As defined herein, the term “communication format” means a manner in which audio, video, audio/video, multimedia, still image and/or web page content is encoded for communication via a communication medium.

As defined herein, the term “user feedback” means a response of a user to information, such as audio, video, audio/video, multimedia and/or still image content, presented to the user.

As defined herein, the term “emotive response” means a response of a user to information, such as audio, video, audio/video, multimedia content and/or still image content, presented to the user, wherein the response indicates an emotion of the user. An emotive response can be, for example, a facial gesture, a body gesture, a hand gesture, and/or the like.

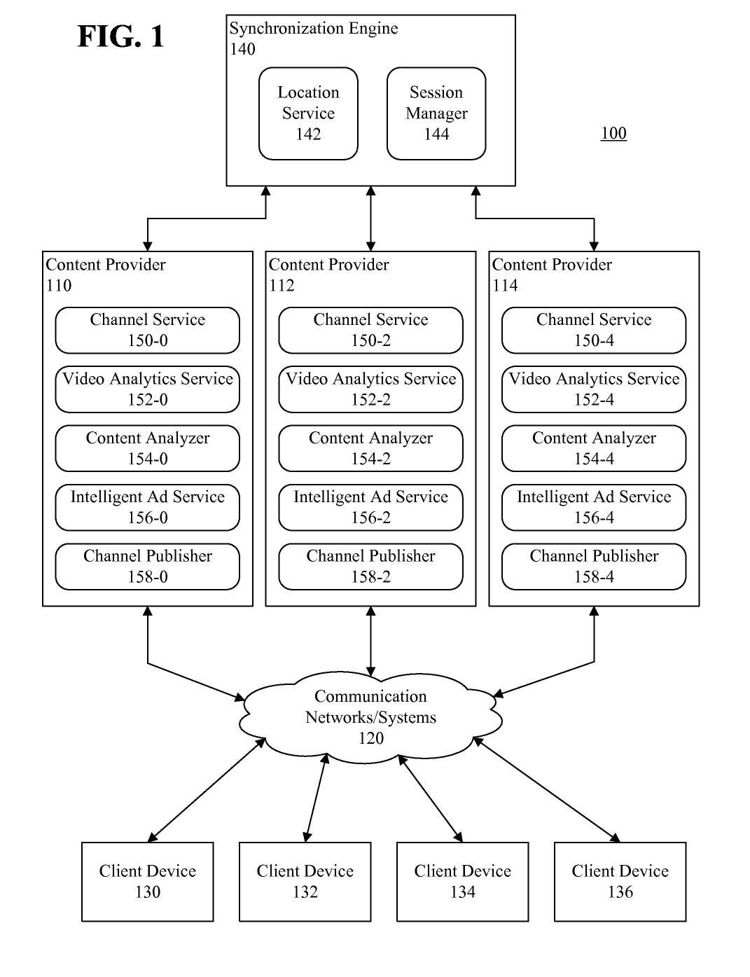

FIG. 1 is a block diagram illustrating an example of a communication system 100 (hereinafter “system 100”). The system 100 can include one or more content providers 110, 112, 114 configured to communicate content to a plurality of users. The content can include audio, video, audio/video and/or multimedia data, for example music, radio programs, television programs, movies and the like. Further, some of the content can be advertisements, as will be described herein. The content providers 110-114 can communicate the content via one or more communication networks/systems 120 to a plurality of client devices 130, 132, 134, 136 used by the users to listen to and/or view the content. Examples of the client devices 130-136 include, but are not limited to, radios, stereo systems, televisions, computers (e.g., desktop computers, laptop computers, tablet computers, etc.), smart phones, gaming consoles, set-top boxes, digital television receivers, analog television receivers, displays, digital billboards, and the like.

The communication networks/systems 120 provide various communication mediums via which the content providers 112-114 communicate content to the client devices 130-136. The communication networks/systems 120 may include connections, such as wire, wireless communication links, or fiber optic cables, as well as equipment well known in the art for delivering content. In this regard, the communication networks/systems 120 can be implemented as, or include, any of a variety of different communication technologies, for example radio transmitters, radio transceivers, television transmitters, television delivery satellites, radio delivery satellites, wired television delivery systems, wired audio delivery systems, digital imaging systems, wide area networks (WANs), local area networks (LANs), wireless networks, mobile networks, Virtual Private Networks (VPNs), the Internet, the Public Switched Telephone Network (PSTN), and the like.

The system 100 also can include a synchronization engine 140. The synchronization engine 140 can be communicatively linked to the content providers 110-114 to facilitate synchronization of advertisements provided to users across multiple communication mediums, as will be described herein. The synchronization engine 140 can include a location service 142 and a session manager 144, and can be executed by one or more servers.

The location service 142 can detect a user's use of a particular communication medium through a variety of ways. For example, the location service 142 can detect the user logging into one or more applications or using one or more subscription content services (e.g., satellite radio, satellite television, cable television, satellite radio, etc.), detect one or more client devices 130-136 being turned on, detect IP and/or media access control (MAC) addresses of the client devices 130-136, detect a physical location and/or physical movement of the user (e.g., detect presence of the user in a vehicle and/or movement of the vehicle, detect presence of the user in front of a television, detect the user being logged into a computer or smart phone, and the like). The location service 142 can implement various technologies to detect such information, for example a global positioning system (GPS), user login systems, camera's and/or other detection equipment associated with the client devices 130-136, obtaining a user's location from a cellular communication provider, and the like. In one aspect, the location service can use multiple technologies to determine a location of a user. For example, if the user's location is indicated by a GPS system or the user's cellular communication provider as the user's home, and the user's television is turned on, the location service 142 can estimate that the user is in front of the user's television, and use this estimate as the determined location. Once the location has been determined, location information can be presented to the session manager 144. In addition, the information can be communicated to one or more intelligent advertisement servers, which will be described, to help determine the best mode of delivery of advertisements to the user.

The session manager 144 can enable movement of user sessions across multiple communication mediums. For example, the session manager 144 can track all communication channels that are assigned to each particular user. Such communication channels can include, but are not limited to, radio and/or internet subscription services, set top box/television subscription services. The session manager 144 also can track IP addresses and/or MAC addresses of the client devices 130-136, track the users' use of the communication channels via the client devices 130-136, track the users' locations via the location service 142, etc. Accordingly, when a user switches from listening and/or viewing content presented in a first communication format via a first communication medium to listening and/or viewing content presented in a second communication format via a second communication medium, the session manager 144 can switch advertisements presented to the user via the first communication medium to the second communication medium. The session manager 144 can do so by communicating with the content provider(s) 110-114 to coordinate communication of advertisements to the client devices 130-136 for presentation to users.

Further, the session manager 144 can store advertising preferences for the user. For example, the session manager 144 can include a user interface via which the user can interact via a client device 130-136 to input the user's advertisement preferences, indicates channels, communication formats and/or communication mediums via which the user chooses to receive advertisements, a nature of advertisements acceptable to the user (e.g., only advertisements suitable for children to view/listen, advertisements suitable for teenagers to view/listen and/or advertisements containing adult content). Moreover, the users can specify their interests and/or user interests can be detected by monitoring user actions, for example using a camera, microphone or the like. In illustration, if a user is paying close attention to certain advertisements and/or to certain portions of the screen where a certain image is shown (e.g., an image of shoes being advertised), such action by the user can indicate a level of interest by the user in the advertisement, product or service. The user also can point to certain parts of the screen to express interest. Still, a user can express interest in any other suitable manner and the present arrangements are not limited in this regard. Accordingly, the session manager 144 can communicate with the content providers 110-114 to target advertisements to individual users based on the users' preferences and/or user interests.

Example components of the content providers 110-114, such as a channel service 150, a video analytics service 152, a content analyzer 154, an intelligent advertisement service 156, and a channel publisher 158 are depicted in FIG. 1. For each content provider 110-114, the channel service 150, video analytics service 152, content analyzer 154, intelligent advertisement service 156 and channel publisher 158 can be executed by one or more servers. For example, one or more servers can be dedicated to execute the channel service 150, one or more servers can be dedicated to execute the video analytics service 152, one or more servers can be dedicated to execute the content analyzer 154, one or more servers can be dedicated to execute the intelligent advertisement service 156, and one or more servers can be dedicated to execute the channel publisher 158. In other arrangements, one or more servers can be tasked with executing two or more of the components 150-158. For example, the video analytics service 152, content analyzer 154 and intelligent advertisement service 156 can be executed by the same server(s). Each of the servers utilized by the content provider 110 can be communicatively linked via a suitable network.

The channel service 150, for example, can track communication mediums and communication formats via which users are receiving content from the content provider 110. Further, the channel service 150 can track different client devices 130-136 being turned on and off by the user, user selection of communication channels, a location of the user and/or physical movement of the user. Such determinations also can be based not only on information received from the client devices 130-136, but also on information received from the synchronization engine 140. In this regard, the channel service 150 and the session manager 144 can communicate with one another accordingly. For instance, the channel service 150 can provide information related to the communication mediums via which the user is receiving content back to the synchronization engine 140. In illustration, mobile communication providers typically know when a mobile telephone phone is receiving information, Internet service providers (ISPs) typically know when a browser is active, set-top box providers may know when the set-top box is on and if a live signal is being transmitted to a television. The channel service 150 can obtain such information and share such information with the synchronization engine 140. Further, the channel service 150 also can obtain additional information about communication mediums and communication formats which are relevant to the synchronization engine 140, such as a user's viewing experience, and communicate such information to the synchronization engine 140 (e.g., to the session manager 144).

The video analytics service 152 can receive video content being communicated by the content provider 110 to at least one client device 130-136 being used by a user and analyze the video content, identify user feedback, such as emotive responses, of one or more users to advertisements, compare the user feedback to previously obtained user feedback, aggregate and/or merge user feedback generated by multiple users, and the like, as will be further described.

The content analyzer 154 can analyze content being presented to the user on a display to identify areas in the content where advertisements may be placed, as also will be further described.

The intelligent advertisement service 156 can receive information analyzed by and/or generated by the content analyzer 154, as well as information obtained from the video analytics service 152, and process such information to make intelligent decisions as to what advertisements to present to user(s) and the manner in which the advertisements are to be presented.

The channel publisher 158 can provide content to users and, when appropriate, provide advertisements to the users at the behest of the intelligent advertisement service 156. The channel publisher 158 can present the content and advertisements in a suitable communication format and over a suitable communication medium for presentation via a client device 130-136. In illustration, if the channel publisher 158 is configured to provide television content, the channel publisher 158 can provide content and advertisements for client devices 130-136 that receive television content. If the channel publisher 158 is configured to provide radio content, the channel publisher 158 can provide content and advertisements for client devices 130-136 that receive radio content. If the channel publisher 158 is configured to provide web content, the channel publisher 158 can provide content and advertisements for client devices 130-136 that receive web content. If the channel publisher 158 is configured to advertisements on digital billboards, the channel publisher 158 can provide the advertisements to one or more digital billboards. In this regard, a particular content provider 110-114 can include more than one channel publisher 158, for example when the content provider provides content via a plurality of communication mediums.

In illustration, information analyzed by and/or generated by the content analyzer 154 can be communicated to the intelligent advertisement service 156. As noted, the intelligent advertisement service 156 can process this information, as well as information obtained from the video analytics service 152, to make intelligent decisions as to what advertisements to present to user(s). By way of example, the intelligent advertisement service 156 can select advertisements that are targeted to the user(s) and for presentation on the client device(s) 130-136 used by the user(s). Such selection can be based, at least in part, on user preferences established with the session manager 144 and the communication medium via which the user(s) is/are receiving content. Further, the intelligent advertisement service 156 can monitor viewing habits of a user, including determining whether the user turned off a client device 130-136, whether the user changed a channel when certain types of advertisements are presented, whether the user has interacted with certain types of advertisements, etc. The intelligent advertisement service 156 can process information gleaned from such monitoring to determine the types of advertisements the user likely will listen to, watch and/or interact, and select these types of advertisements for presentation to the user.

Moreover, the components 142-144 of the synchronization engine 140 and the components 150-158 of the content providers 110-114 are configured to provide a unified advertisement experience across multiple communication mediums. In this regard, the components 142-144, 150-158 can communicate with one another to provide a wide variety of options for providing advertisements to users via client devices 130-136. Various options for providing advertisements are presented in the following examples.

In one example, a user can be listening to and/or viewing a first advertisement communicated by the content provider 110 (e.g., using the channel publisher 158-0) via first communication medium in a first communication format using the client device 130. For example, the first advertisement can be presented to the user via a radio in the user's vehicle, and the first communication format can be an audio format. The channel service 150-0 can identify which communication medium (e.g., which communication channel) provided by the content provider 110, and communicate corresponding information to the location service 142. In response to the user turning off the client device 130 or leaving an area serviced by the client device (e.g., the user turns off the radio or the car), the channel service 150-0 and/or location service 142-0 can detect that the user no longer is using the client device 130. The user, however, may turn on another client device, such as the client device 132. For example, the user may leave the vehicle, enter the user's dwelling, and turn on a television. The channel service 150 for the content provider 110-114 that provides content to the client device 132 can detect the client device 132 being turned on and, optionally, a channel accessed by the user, and send corresponding information to the location service 142 and/or the location service 142 can receive such information directly from the client device 132. In this example, assume the content provider 112 provides content to the client device 132. Accordingly, the channel service 150-2 can detect the client device 132 being turned on and the channel being accessed by the user, and send corresponding information to the location service 142.

Responsive to the user accessing the client device 132 to receive content, the session manager 144 can receive from the intelligent advertisement service 156-0, for example in response to a query generated by the session manager 144, information related to a first advertisement that was presented to the user via the client device 130, and communicate to the intelligent advertisement service 156-2 such information. In another arrangement, the session manager 144 can initiate a communication session being established between the intelligent advertisement service 156-0 and the intelligent advertisement service 156-2 to exchange information related to advertisements presented or to be presented to the user. Regardless of how the intelligent advertisement service 156-2 receives information related to advertisements, the intelligent advertisement service 156-2 can select a second advertisement to present to the user via the client device 132, and the content provider 112 can communicate the second advertisement (e.g., using the channel publisher 158-2) via a second communication medium using a second communication format via which the client device 132 receives content from the content provider 112. For example, the second advertisement can be communicated on a television channel the user has accessed. The second advertisement can be presented to the user between other program information presented on the television channel, or otherwise presented to the user on a display in a manner that does not significantly interfere with other information being presented to the user on the display (e.g., in white space or other regions of the display), which will be further described.

In one arrangement, the first advertisement can be a first portion of an advertisement presentation, and the second advertisement can be a second portion of the advertisement presentation. In another arrangement, the second advertisement can be selected by the intelligent advertisement service 156-2 to reinforce a message being communicated by the first advertisement. Further, the second advertisement can be presented in accordance with at least one user preference specifying a manner in which the second advertisement is to be presented, and the second advertisement can be presented to the user accordingly. For example, the user preference can specify the second communication medium and/or communication format, and the second advertisement can be presented to the user via the second communication medium and/or communication format based on the user preference.

In the above example, specific communication mediums and communication formats are discussed for purposes of explanation. It will be appreciated, however, that the example can be extended to other communication mediums and communication formats, such as those previously described. In illustration, where the example discusses the second advertisement being presented to the user between other program information presented on the television channel, in another arrangement the second advertisement can be presented to the user between other program information presented to the user on an audio channel. Still, a myriad of other examples are clearly apparent from the examples presented herein and the present arrangements are not limited in this regard.

In another example, the session manager 144, processing information received from the location service 142 and information from one or more of the content providers 110-114, can determine that a user of the client device 130 is proximate to a billboard (e.g., the client device 136) when a first advertisement is presented on the billboard. Responsive to such determination, the session manager 144 can coordinate with the intelligent advertisement service 156 of one or more of the content providers 110-114 to present a second advertisement to the user that is associated with a first advertisement. The second advertisement, for example, can be presented via a radio in the user's vehicle (e.g., the client device 130), or presented when the user accesses the client device 132 and/or the client device 134.

In another example, a user can be presented a first advertisement on a first channel being received by a client device, for instance the client device 130, and the user may change the channel during presentation of the first advertisement. The channel service 150-0 and/or session manager 144 can detect the channel change during presentation of a first advertisement, and intelligent advertisement service 156-0 can continue presentation of the first advertisement (e.g., via the channel publisher 158-0) on the newly selected channel. In another aspect, the channel service 150-0 and/or session manager 144 can detect the channel change after presentation of a first advertisement, and intelligent advertisement service 156-0 can present a second advertisement on the newly selected channel.

In another example, one or more of the client devices 130-136 can include a camera or can be operatively connected to a camera, and communicate video of the user or users to the video analytics service(s) 152 of the content provider(s) 110-114 providing content to the client device(s) 130-136. In illustration, assume the client device 132 is a television receiving content from the content provider 112. A camera in or connected to the client device 132 can capture user feedback of one or more users, for example one or more emotive responses, responsive advertisements presented by the client device 132, and the client device 132 can communicate such user feedback to the video analytics service 152-2. The video analytics service 152-2 can analyze the user feedback and advertisement content presented on the client device 132, and such analysis can be processed by the video analytics service 152-2 and/or intelligent advertisement service 156-2 to determine a next course of action to take with regard to presenting advertisements to user(s).

In illustration, if a user's emotive response indicates frustration when an advertisement is presented during a game, the video analytics service 152-2 can determine that presentation of the advertisement should be ceased, and communicate such determination to the intelligent advertisement service 156-2. In response, the intelligent advertisement service 156-2 can cease presentation of the advertisement. Further, the intelligent advertisement service 156-2 can re-schedule resumption of presentation of the advertisement for a later time and/or replace the advertisement with another advertisement. Moreover, the advertisement service 156-2 and/or other advertisement services 156 can select one or more other advertisements to be presented to the user, for example in the same communication format as the subject advertisement and/or using the same communication medium, or presented to the user in another communication format and/or using another communication medium, based on the user feedback, and present such other advertisement(s) accordingly.

In addition, the video analytics service 152-2 can compare presently or recently received user feedback to past user feedback, aggregate user feedback from multiple users, aggregate user feedback received from different client devices 130-136 correlating to a particular advertisement, etc. Such information also can be processed by the video analytics service 152-2 and/or intelligent advertisement service 156-2 to determine a next course of action to take with regard to presenting advertisements to user(s).

In another example, while an advertisement is displayed to one or more users, the video analytics service 152-2 can detect whether the user has left the viewing area and, if so, communicate with the intelligent advertisement service 156-2 to temporarily withhold displaying the advertisement until the user is back in the viewing area. In yet another example, the video analytics service 152-2 can detect that the user is viewing content with a plurality of users, such as the users' family and communicate corresponding information to the intelligent advertisement service 156-2. Accordingly, the intelligent advertisement service 156-2 can determine which advertisements are appropriate for presentation to the users' family, and select only such advertisements for presentation via the client device 132. In one aspect, user preferences can be processed to determine which advertisements may be appropriate and the manner in which advertisements should be presented. For example, the user preferences can specify that when multiple users are present near the television, only advertisements appropriate for users of all ages should be presented. The user preferences also can specify that advertisements suitable for those over the age of 13 may be displayed, or specify that advertisements containing adult content may be displayed. The user preferences also can specify how the user desires to view advertisements, for example presented as text banners, overlaid in the white space or the other regions that do not include main content, associated with objects presented in content, presented during pauses in audio content, etc.

In another example, the video analytics service 152 can enhance an advertisement viewing experience using a second display. For example, the video analytics service 152-0 can determine that a plurality of users are viewing content on a particular client device 130, such as a television, and communicate with the intelligent advertisement service 156-0 to select a particular advertisement for presentation on that client device 130. In addition, if one or more users also have access to other client devices 132-136, such as smart phones or tablet computers, another advertisement related to the advertisement being presented on the client device 130 can be presented on one or more of the other client devices 132-136. In illustration, if a user selects a first advertisement presented on a first display, a second advertisement or additional information related to the first advertisement can be presented on a second display. If a client device 132, for example, is provided content from another content provider, such as the content provider 112, the session manager 144 can communicate with both of the video analytics services 152-0, 152-2 and/or both of the intelligent advertisement services 156-0, 156-2 to coordinate presentation of the respective advertisements and/or information. This can serve to reinforce the message being communicated in the advertisements. In one aspect, user preferences can be processed to determine which other client devices 132-136 should be used to present the other advertisement and/or the manner in which advertisements should be presented.

In another example, the content analyzer 154, for instance the content analyzer 154-0, can analyze content being presented to one or more users on a display to identify areas in the content that have white space, and determine that this white space is suitable for presenting advertisements to the user(s) by embedding the advertisements in other displayed content without significantly disrupting users' experiences. In this regard, the content analyzer 154-0 can dynamically determine the size and space available to present one or more advertisements in the white space. The content analyzer 154-0 also can identify one or more regions in displayed content that do not include main content (e.g., regions of a webpage, game or the like with which a user is not interacting), and determine that one or more of these regions is suitable for presenting advertisements to the user(s) by embedding the advertisements in other displayed content without significantly disrupting users' experiences. Again, the content analyzer 154-0 can dynamically determine the size and space available to present one or more advertisements in the identified region(s). The content analyzer 154-0 also can determine appropriate timing of when to place advertisements in the white space or the other regions that do not include main content. In the case of mobile device advertisements, the content analyzer 154-0 also can determine appropriate placement of minimalistic text advertisements that the user can select for more information. Optionally, the user can be provided an option to turn off advertisements embedded with other displayed content.

In one aspect, the advertisements can be presented in accordance with a user preference, for example as text scrolling across the bottom of a display. Further, advertisements can be presented on a display in a manner that associates the advertisements with at least one object presented on the display. In illustration, if an athlete in a game being presented on the display is wearing a particular brand of clothing, and advertisement related to the clothing can be presented near the athlete or embedded over the subject clothing. A determination of whether to present such advertisements can be based, at least in part, on user preferences, such as user preferences established via the session manager 144, and information that is analyzed by the content analyzer 154-0. In this regard, such advertisements can be selected by the intelligent advertisement service 156-0 based on the user's interest indicated in the user preferences. Further the content analyzer 154-0 and/or the intelligent advertisement service 156-0 can determine advertisement content type, size, and location for placement of advertisements on a display. The content analyzer 154 also can determine where information which enables the user to interact with advertisements of interest may be embedded into the content. The content analyzer 154-0 and/or intelligent advertisement service 156-0 can embed content accordingly. Further, specific incentives can be indicated in the advertisements. For example, when specific incentives are available for a product, service or event represented by an advertisement, the size of the advertisement can be increased and/or other visual effects can be applied to the advertisement. In one aspect, the advertisements can present interactive auctions on a display via which users can bid on products and/or services.

In one arrangement, the user can select advertisements presented on a display using a user input device. The channel service 150-0 and/or session manager 144 can detect such user selection and, in response, the intelligent advertisement service 156-0 can provide present additional information related to the product, service or event associated with the advertisement. Moreover, when user selections indicate a high user interest in a product, service or event associated with an advertisement, the intelligent advertisement service 156-0 can notify the advertiser for whom the advertisement is presented of such user interest. In one arrangement, in response to identifying such user interest, specific incentives available for a product, service or event can be presented to the user.

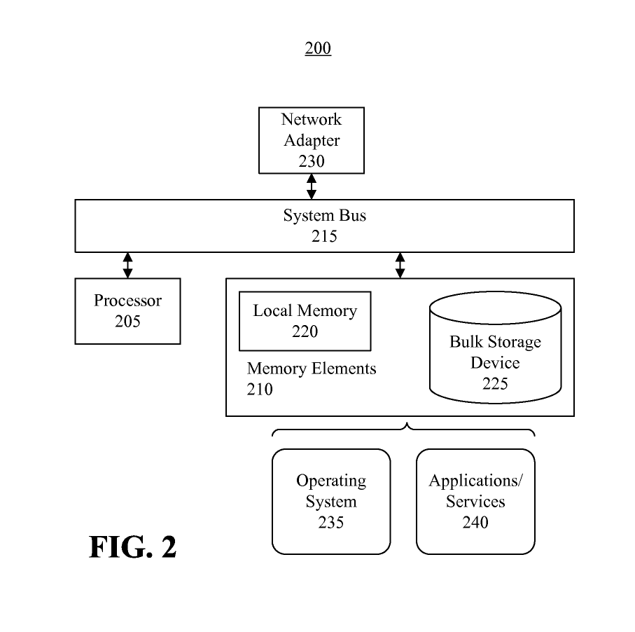

FIG. 2 is a block diagram illustrating example architecture for a data processing system (hereinafter “system”) 200, which may be used as one or more of the servers described herein. The system 200 includes at least one processor 205 coupled to memory elements 210 through a system bus 215 or other suitable circuitry. As such, the system 200 can store program code within the memory elements 210. The processor 205 executes the program code accessed from the memory elements 210 via the system bus 215 or the other suitable circuitry.

In one aspect, the system 200 is implemented as a computer or other programmable data processing apparatus that is suitable for storing and/or executing program code. It should be appreciated, however, that the system 200 can be implemented in the form of any system including a processor and memory that is capable of performing and/or initiating the functions and/or operations described within this disclosure. Further, the system 200 can be implemented in any of a variety of different form factors.

The memory elements 210 include one or more physical memory devices such as, for example, local memory 220 and one or more bulk storage devices 125. Local memory 220 refers to RAM or other non-persistent memory device(s) generally used during actual execution of the program code. Bulk storage device(s) 125 can be implemented as a hard disk drive (HDD), solid state drive (SSD), or other persistent data storage device. The system 200 also can include one or more cache memories (not shown) that provide temporary storage of at least some program code in order to reduce the number of times program code must be retrieved from bulk storage device 125 during execution.

One or more network adapters 230 also can be coupled to the system 200 to enable the system 200 to become coupled to other systems, computer systems, remote printers, and/or remote storage devices through intervening private or public networks. Modems, cable modems, wireless transceivers, and Ethernet cards are examples of different types of network adapters 230 that can be used with the system 200. though the present arrangements are not limited in this regard.

As pictured in FIG. 2, the memory elements 210 can store at least one operating system 235 and one or more applications and/or services 240, such as the services previously described. The operating system 235 and the one or more applications/services 240, being implemented in the form of executable program code, are executed by the system 200 and, as such, are considered an integrated part of the system 200. Moreover, the operating system 235 and more applications/services 240, including any parameters and/or attributes utilized by the operating system 235 and more applications/services 240, are functional data structures that impart functionality when employed as part of the system 200.

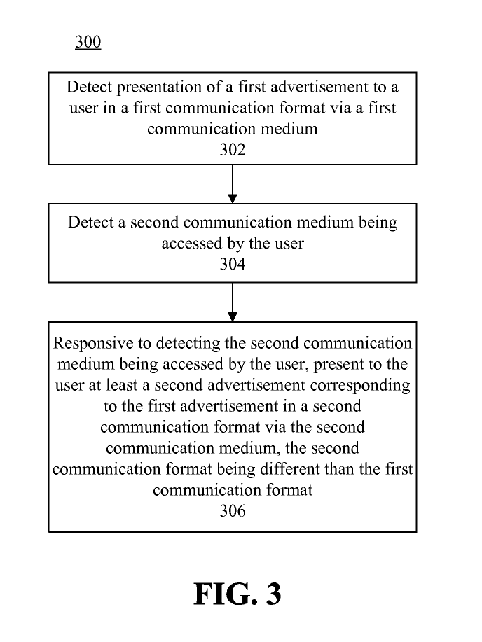

FIG. 3 is a flow chart illustrating an example of a method 300 of presenting advertisements to a user. At step 302, presentation of a first advertisement to a user in a first communication format via a first communication medium can be detected, for example via the synchronization engine 140 and/or one or more content providers 110-114 of FIG. 1. At step 304, a second communication medium being accessed by the user can be detected, for example via the synchronization engine 140 and/or one or more content providers 110-114. At step 306, responsive to detecting the second communication medium being accessed by the user, at least a second advertisement corresponding to the first advertisement can be presented to the user in a second communication format via the second communication medium, for example via the intelligent advertisement service 156 of FIG. 1. In one arrangement, the second communication format can be different than the first communication format, though this need not be the case.

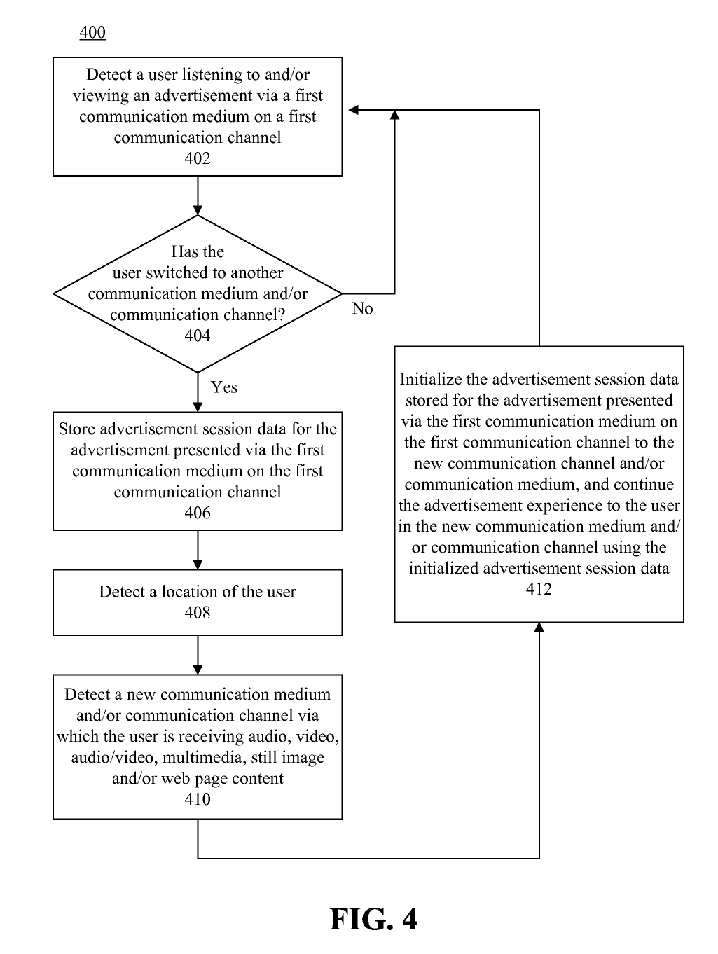

FIG. 4 is a flow chart illustrating an example of a method 400 of presenting advertisements to a user. At step 402, a user listening to and/or viewing an advertisement via a first communication medium on a first communication channel can be detected, for example by the synchronization engine 140 and/or one or more content providers 110-114 of FIG. 1. At decision box 404, a determination can be made as to whether the user has switched to another channel communication medium and/or communication channel, for example by the synchronization engine 140 and/or one or more content providers 110-114 of FIG. 1. If not, the process can return to step 402. If so, the process can proceed to step 406.

At step 406, advertisement session data for the advertisement presented via the first communication medium on the first communication channel can be stored, for example by the session manager 144 of FIG. 1. At step 408, a location of the user can be detected, for example by the location service 142 of FIG. 1. At step 410, a new communication medium and/or communication channel via which the user is receiving audio, video, audio/video, multimedia, still image and/or web page content can be detected, for example by the synchronization engine 140 and/or one or more content providers 110-114.

At step 412, advertisement session data stored for the advertisement presented via the first communication medium on the first communication channel can be initialized to the new communication channel and/or communication medium, and the advertisement experience can be continued to the user in the new communication medium and/or communication channel using the initialized advertisement session. Step 412 can be performed by the synchronization engine 140 and/or one or more content providers 110-114. The process then can proceed to step 402 and continue.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” or similar language means that a particular feature, structure, or characteristic described in connection with the embodiment is included in at least one embodiment described within this disclosure. Thus, appearances of the phrases “in one embodiment,” “in an embodiment,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
detecting presentation of a first advertisement to a user in a first communication format via a first communication medium;
detecting, by at least one processor, a second communication medium being accessed by the user; and
responsive to detecting the second communication medium being accessed by the user, presenting to the user at least a second advertisement corresponding to the first advertisement in a second communication format via the second communication medium, the second communication format being different than the first communication format.

2. The method of claim 1, wherein:
the first advertisement is a first portion of an advertisement presentation; and
the second advertisement is a second portion of the advertisement presentation.

3. The method of claim 1, further comprising:
detecting at least one user feedback responsive to the first advertisement or the second advertisement; and
selecting the second advertisement as presented to the user in the second communication format based at least on the at least one user feedback.

4. The method of claim 3, wherein detecting the at least one user feedback comprises detecting an emotive response of the user to the first advertisement or the second advertisement.

5. The method of claim 1, further comprising:
detecting at least one user preference specifying a manner in which the second advertisement is to be presented;
wherein presenting to the user at least the second advertisement corresponding to the first advertisement in the second communication format via the second communication medium comprises presenting the second advertisement in accordance with the at least one user preference specifying a manner in which the second advertisement is to be presented.

6. The method of claim 1, wherein:
detecting the second communication medium accessed by the user comprises detecting a particular channel accessed by the user; and
presenting to the user at least the second advertisement corresponding to the first advertisement in the second communication format via the second communication medium comprises presenting the second advertisement to the user between other program information presented to the user on the particular channel.

7. The method of claim 1, wherein:
presenting to the user at least the second advertisement corresponding to the first advertisement in the second communication format via the second communication medium comprises presenting the second advertisement in a manner that associates the second advertisement with objects presented in content provided via the second communication medium.

8. A system, comprising:
a processor programmed to initiate executable operations comprising:
detecting presentation of a first advertisement to a user in a first communication format via a first communication medium;
detecting a second communication medium being accessed by the user; and
responsive to detecting the second communication medium being accessed by the user, presenting to the user at least a second advertisement corresponding to the first advertisement in a second communication format via the second communication medium, the second communication format being different than the first communication format.

9. The system of claim 8, wherein:
the first advertisement is a first portion of an advertisement presentation; and
the second advertisement is a second portion of the advertisement presentation.

10. The system of claim 8, the executable operations further comprising:
detecting at least one user feedback responsive to the first advertisement or the second advertisement; and
selecting the second advertisement as presented to the user in the second communication format based at least on the at least one user feedback.

11. The system of claim 10, wherein detecting the at least one user feedback comprises detecting an emotive response of the user to the first advertisement or the second advertisement.

12. The system of claim 8, the executable operations further comprising:
detecting at least one user preference specifying a manner in which the second advertisement is to be presented;
wherein presenting to the user at least the second advertisement corresponding to the first advertisement in the second communication format via the second communication medium comprises presenting the second advertisement in accordance with the at least one user preference specifying a manner in which the second advertisement is to be presented.

13. The system of claim 8, wherein:
detecting the second communication medium accessed by the user comprises detecting a particular channel accessed by the user; and
presenting to the user at least the second advertisement corresponding to the first advertisement in the second communication format via the second communication medium comprises presenting the second advertisement to the user between other program information presented to the user on the particular channel.

14. The system of claim 8, wherein:
presenting to the user at least the second advertisement corresponding to the first advertisement in the second communication format via the second communication medium comprises presenting the second advertisement in a manner that associates the second advertisement with objects presented in content provided via the second communication medium.

15. A computer program product comprising a computer readable storage medium having program code stored thereon, the program code executable by at least one processor to perform a method comprising:
detecting, by the at least one processor, presentation of a first advertisement to a user in a first communication format via a first communication medium;
detecting, by the at least one processor, a second communication medium being accessed by the user; and
responsive to detecting the second communication medium being accessed by the user, presenting, by the at least one processor, to the user at least a second advertisement corresponding to the first advertisement in a second communication format via the second communication medium, the second communication format being different than the first communication format.

16. The computer program product of claim 15, wherein:
the first advertisement is a first portion of an advertisement presentation; and
the second advertisement is a second portion of the advertisement presentation.

17. The computer program product of claim 15, the method further comprising:
detecting at least one user feedback responsive to the first advertisement or the second advertisement; and
selecting the second advertisement as presented to the user in the second communication format based at least on the at least one user feedback.

18. The computer program product of claim 17, wherein detecting the at least one user feedback comprises detecting an emotive response of the user to the first advertisement or the second advertisement.

19. The computer program product of claim 15, the method further comprising:
detecting, by the at least one processor, at least one user preference specifying a manner in which the second advertisement is to be presented;
wherein presenting to the user at least the second advertisement corresponding to the first advertisement in the second communication format via the second communication medium comprises presenting the second advertisement in accordance with the at least one user preference specifying a manner in which the second advertisement is to be presented.

20. The computer program product of claim 15, wherein:
detecting the second communication medium accessed by the user comprises detecting a particular channel accessed by the user; and
presenting to the user at least the second advertisement corresponding to the first advertisement in the second communication format via the second communication medium comprises presenting the second advertisement to the user between other program information presented to the user on the particular channel.
